(19) United States
(12) Patent Application Publication
(10) Pub. No.: US 2014/0270347 A1
(43) Pub. Date: Sep. 18, 2014

(54) HIERARCHICAL IMAGE CLASSIFICATION SYSTEM

(71) Applicant: SHARP LABORATORIES OF AMERICA, INC., Camas, WA (US)

(72) Inventors: Xinyu XU, Camas, WA (US); Xu CHEN, Vancouver, WA (US); Petrus J.L. VAN BEEK, Camas, WA (US)

(73) Assignee: SHARP LABORATORIES OF AMERICA, INC., Camas, WA (US)

(21) Appl. No.: 13/798,760

(22) Filed: Mar. 13, 2013

(51) Int. Cl. G06K 9/46

(52) U.S. Cl. CPC G06K 9/46
USPC 382/103; 382/155; 382/159; 382/199

(57) ABSTRACT

A technique for image processing that includes receiving a model image, an input image, and registering the input image with the model image. A modified input image is determined that includes a first component that is substantially free of error components with respect to the model image and a second component that is substantially free of non-error aspects with respect to the model image. The technique determines an improved alignment of the modified input image with the model image where the improved alignment and the first and second components are determined jointly.

### CROSS-REFERENCE TO RELATED APPLICATIONS

None.

### BACKGROUND OF THE INVENTION

The present invention relates generally to a hierarchical classification system and/or a defect detection system for an image.

Referring to FIG. 1, template matching is a commonly used technique in order to perform alignment between multiple images or to recognize content in an image for classification. The template matching technique includes a given target object in a model image, and automatically finding the position, orientation, and scaling of the target object in input images. Generally, the input images undergo geometric transforms (translation, rotation, zoom, etc) and photometric changes (brightness/contrast changes, blur, noise, etc). In the context of template matching and defect detection, the relevant characteristics of the target object in the model image may be assumed to be known before the template matching to the target image is performed. The target object in the model image is generally considered to contain an “ideal” and “defect-free” view of the product or parts of the product. Such characteristics of the target object may be extracted, modeled, and learned previously in a manner that may be considered “off-line,” while the matching of those characteristics to the input image may be considered “on-line.” Thus, the input image contains a view of the product under inspection and is compared with the template image to align the two images and to detect defects or otherwise classify the content.

One type of alignment technique includes feature point based alignment. Feature point based alignment extracts discriminative interesting points and features from the model image and the input images. Then those features are matched between the model image and the input images with K-nearest neighbor search or some feature point classification technique. Then a homography transformation is estimated from those matched feature points, which may further be refined.

Feature point based alignment works well when target objects contain a sufficient number of interesting feature points. Feature point based alignment typically fails to produce a valid homography when the target object in the input or model image contains few or no interesting points (e.g. corners), or the target object is very simple (e.g. target object consists of only edges, like paper clip) or symmetric, and/or the target object contains repetitive patterns (e.g. machine screw). In these situations, too many ambiguous matches prevents generating a valid homography. To reduce the likelihood of such failure, global information of the object such as edges, contours, or shape may be utilized instead of merely relying on local features.

Another type of alignment technique is to search for the target object by sliding a window of a reference template in a point-by-point manner, and computing the degree of similarity between them, where the similarity metric is commonly given by correlation or normalized cross correlation. Pixel-based template matching is very time-consuming and computationally expensive. For an input image of size N×N and the model image of size W×W, the computational complexity is O(W²×N²), given that the object orientation in both the input and model image is coincident. When searching for an object with arbitrary orientation, one technique is to do template matching with the model image rotated in every possible orientation, which makes the matching scheme far more computationally expensive.

With regard to image classification, many techniques involve using nearest neighbor classifier, Naïve Bayes classifier, Neural Networks, decision trees, multi-variate regression model, and support vector machines. Often each of these techniques involve using a classification technique where category models are learned from initial labeled training data and then each testing example is assigned to a class out of a finite and small set of classes.

Defect detection based upon a supervised classification is one detection category. However, often it is difficult to gather a reasonable size of training samples with labeled defect masks, which requires cumbersome manual annotation. Labeling by human operators leads to severe waste of resources to produce such samples, especially given that new datasets and defects periodically arise. Given the high intra-class and inter-class variance of potential defects, designing suitable features tends to be problematic.

Another category of defect detection views defect detection as saliency detection. Saliency detection typically estimates coarse and subjective saliency support on natural images, and often leads to severe over detections while making a number of assumptions in the process.

Another category of defect detection views defect detection as anomaly detection. For example, analyzing the input image in the Fourier domain may only locate small defects on uniformly textured or periodic patterned images, such as a fabric surface. The anomaly detection process is not suitable for large sized defects.

Another category of visual defect detection is based on the use of a defect free “reference” or “model” image. The model image may contain an “ideal” view of the product or parts thereof. The input image may contain a view of the product under inspection and is compared with the model image to detect defects. In principle, deviations or differences from the model image present in the input image may indicate one or more defects.

What is desired therefore is a computationally efficient classification technique and/or a computationally efficient defect detection technique.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates template matching.

FIG. 2 illustrates a model image, an input image, and an output image.

FIG. 3 illustrates another model image, an input image, and an output image.

FIG. 4 illustrates another model image, an input image, and an output image.

FIG. 5 illustrates various defects.

FIG. 6 illustrates a flat classification technique.

FIG. 7 illustrates a hierarchical classification technique.

FIG. 8 illustrates a hierarchical classification of LCD defects.

FIG. 9 illustrates another hierarchical classification of LCD defects.

FIG. 10 illustrates classifiers suitable for the classification of FIG. 8.

FIG. 11 illustrates classifiers suitable for the classification of FIG. 9.

FIG. 12 illustrates a flow chart for training classifiers for FIG. 8.

FIG. 13 illustrates a flow chart for training classifiers for FIG. 9.

FIG. 14 illustrates a flow chart for testing prediction for FIG. 8.

FIG. 15 illustrates a flow chart for testing prediction for FIG. 9.

FIG. 16 illustrates an exemplary defect detection process.

FIG. 17 illustrates an exemplary weighted matching.

FIG. 18 illustrates an exemplary alignment of an input image to a model image.

FIG. 19 illustrates an exemplary background and landmark replacement technique.

FIG. 20 illustrates an exemplary noise suppression technique.

FIG. 21 illustrates an exemplary LCD defect detection technique.

FIG. 22 illustrates an exemplary an exemplary defect selection technique.

FIG. 23 illustrates an exemplary GI defect process.

FIG. 24 illustrates an exemplary GI defect identification.

FIG. 25 illustrates an exemplary GI defect detection architecture.

FIG. 26 illustrates an exemplary GI defect detection based upon a first criteria.

FIG. 27 illustrates an exemplary GI defect detection based upon a second criteria.

FIG. 28 illustrates an exemplary GI defect detection based upon a third criteria.

FIG. 29 illustrates an exemplary GI defect detection based upon a fourth criteria.

FIG. 30 illustrates an exemplary GI defect detection based upon a fifth criteria.

### DETAILED DESCRIPTION OF PREFERRED EMBODIMENT

Referring to FIG. 2, in many cases a model image has a limited set of feature points but tends to have relatively sharp edge features. One such example is a paperclip. Then using a suitable matching technique it is desirable to find a matching object in one or more input images, in a computationally efficient manner. The matching object may be at an unknown position and at an unknown rotation.

Referring to FIG. 3, in many cases the input image may have one or more matching objects of interest, which may be overlapping with one another. Then using a suitable matching technique it is desirable to find matching objects in one or more input images, in a computationally efficient manner. The matching objects may be at an unknown position and at an unknown rotation.

Referring to FIG. 4, in many cases the input image may have one or more matching objects of interest, which may be overlapping with one another. Then using a suitable matching technique it is desirable to find matching objects in one or more input images, in a computationally efficient manner. The matching object may be at an unknown position, unknown rotation, and unknown scale.

Referring again to FIG. 2, FIG. 3, and FIG. 4, the matching technique should be computationally efficient, while being sufficiently robust to distinguish image features such as sharp corners, significant edges, or distinguish images with relatively few such features. Moreover, the matching technique should be sufficiently robust to reduce effects due to lighting or illumination changes in the image, blur in the image, noise in the image, and other imaging imperfections.

Referring to FIG. 5, an exemplary defect from a liquid crystal panel is illustrated that has an arbitrary shape, an exemplary defect from a liquid crystal panel is illustrated that has a weak intensity, an exemplary defect from a liquid crystal panel is illustrated that is generally specific to the object class being examined, and an exemplary defect from a liquid crystal panel is illustrated that is relatively large is size and has the general characteristics of a gradual change in color. As illustrated in such examples, the defects are highly variable in terms of appearance, size, type, and may be specific to the object class being inspected. In each of these examples, it would be desirable to be able to accurately detect the defect using a generalized and robust system that is suitable for different defects and even previously unknown defects.

In general, an image classification problem can be defined as: given a set of training examples composed of pairs {xᵢ, yᵢ}, find a function f(x) that maps each xᵢ to its associated class yᵢ, i=1, 2, . . . , n, where n is the total number of training examples. After training, the predictive accuracy of the learned classification function is evaluated by using it to classify a set of unlabeled examples, unseen during training. This evaluation measures the generalization ability (i.e., predictive accuracy) of the learned classification function. Classification has many applications, including for example, text classification (e.g., document and web content), image classification, object classification, image annotation (e.g., classify image regions into different areas), face classification, face recognition, biological classification, biometric identification, handwriting recognition, medical image classification, drug discovery, speed recognition, and Internet search engines.

Many classification problems tend to have relatively complex hierarchical structures, such as for example, genes, protein functions, Internet documents, and images. Using a classification technique that is likewise hierarchical in nature tends to work well on such problems, especially when there are a large number of classes with a large number of features. Non-hierarchical techniques, such as those that treat each category or class separately, are not especially suitable for a large number of classes with a large number of features. By utilizing known hierarchical structures, a hierarchical classification technique permits the effective classification of a large number of classes with a large number of features by splitting the classes into a hierarchical structure. At the root level in the category hierarchy, a sample may be first classified into one or more sub-categories using a classification technique. The classification may be repeated on the sample in each of the sub-categories until the sample reaches leaf categories or is not suitable to be further classified into additional sub-categories. Each of such classification selections may be processed in an independent manner, and in an efficient manner using parallel processors.

Referring to FIG. 6, the nodes represent classes, where each node except the root node is labeled as a category (e.g., 1, 2, 3) 100. Accordingly, there is a single level of non-hierarchical classes to be assigned to a sample.

Referring to FIG. 7, for an exemplary hierarchical classification technique the data is first divided into 3 sub-classes 110, where each of the three sub-classes may be virtual categories or real categories. Then class 1 120 is divided into two sub-classes, 1.1 122 and 1.2 124; class 2 130 is divided into three sub-classes, 2.1 132, 2.2 134, and 2.3 136; and class 3 140 is divided into is divided into three sub-classes, 3.1 142, 3.2 144, and 3.3 146. The class hierarchy in the hierarchical classification offers increased flexibility to specify at which level of the hierarchy a class will be assigned.

The use of hierarchical decomposition of the classification permits efficiencies in both the learning and the prediction phases. Each of the individual classifications is smaller than the original problem, and often it is feasible to use a much smaller set of features for each of the classifications. The hierarchical classification technique may take into account the structure of the class hierarchy, permitting the exploitation of different sets of features with increased discrimination at different category levels, whereas a flat classification technique would ignore the information in the structure of the class hierarchy. The hierarchical classification framework is also flexible enough to adapt to changes in the category structure. The hierarchical classification framework also facilitates the adaptation to changes in the category structure. In addition, the use of such a hierarchical structure often leads to more accurate specialized classifiers. Moreover, at each level or portion thereof, any classification technique, such as SVM, Random Treess, Neural Networks, and/or Bayesian classifier may be used as the classification technique.

One technique for implementing a hierarchical classification technique is to transform the original hierarchical classification into a set of flat classifications, with one flat classification for each level of the class hierarchy, and then use a flat classification technique to solve each of these levels independently of the others. For example, in FIG. 7, the associated hierarchical classification may be transformed into two independent classifications, namely, predicting the classes at the first level 110 and predicting the classes at the second level 150. A flat classification technique is applied to each of these levels independently, i.e., each of the two runs ignores the result of the other. For example, the system may train a 3-class classifier for the first level and train a 7 class classifier for the second level. When training the 3-class classifier, training samples of class 1.1 and 1.2, may be labeled as class 1, training samples of class 2.1, 2.2, and 2.3 may be labeled class 2, training samples of class 3.1, 3.2, and 3.3 may be labeled class 3. The 3 class first level classifier and the 7 class second level classifier may be applied independently in the test phase to assign a label to a test sample.

In this framework, the two independent runs effectively correspond to two distinct flat classifications. In other words, the multiple runs of the classification technique are independent both in the training phase and the test phase. While beneficial, this approach does not guarantee that the classes predicted by the independent runs at the different class levels will be compatible with each other. For instance, it is possible to have a situation where the classifier at level 1 assigns a test example to class 1, while the classifier at level 2 assigns the example to class 2.1, which is inconsistent with the first level prediction.

A modified hierarchical classification technique may use multiple runs of independent training but further include top-down classification during testing. In such a modified hierarchical classification, in the training phase the class hierarchy is processed one level at a time (or otherwise independently), producing one or more classifiers for each internal class node. In the test phase, each sample may be classified in a top-down fashion. For example, the test sample may be assigned to one or more classes by the first-level classifier(s). Then the second level classifier(s) may assign this sample to one or more sub-classes of the class(es) predicted at the first level. This process may be continued until the sample's class(es) are predicted at the deepest available level.

To create a hierarchical set of classifiers using the top-down technique, the system may either train a single multi-class classifier for each internal class node, or train multiple binary classifiers for each internal class node. In the former case, the system may use a multi-class classification technique such as multi-class SVM, Random Trees, and/or Decision Trees. Thus, at each class level, the system may build a classifier that predicts the class(es) of a sample at that level. In the latter case, the system may train multiple binary classifiers at each internal class node. Therefore, for each test sample and for each class level, the system may present the sample to each of the binary classifiers at that level. As a result, the test example may be assigned to one or more classes at each level, and this information may be taken into account at the next level.

The top down approach has the advantage that each classification model for a single class node is induced to solve a more modular, focused classification. The modular nature of the top-down approach may also be exploited during the test phase, where the classification of a sample at a given class level guides its classification at the next level. However, the top down approach has the disadvantage that, if a test example is misclassified at a certain level, it tends to be misclassified at all the deeper levels of the hierarchy.

During the training of the top-down hierarchical classification, a classifier may be learned, or multiple classifiers may be learned, for each internal (non-leaf) node of the tree hierarchy. At each internal node, the technique may use a set of features discriminating among all the classes associated with the child nodes of this internal node. For instance, at the root node, the technique may use features discriminating among the first-level classes 1, 2, . . . , k0, where k0 is the number of first level classes (child nodes of the root node). At the node corresponding to class 1, the technique may use features discriminating among the second level classes 1.1, 1.2, . . . k1, where k1 is the number of child classes of the class 1, and so forth. The features used at each internal node may be automatically discovered by a feature selection technique (e.g., using mutual information between a feature F and a category C), or they can be defined by an operator where the operator selects the most discriminating features for differentiating the sub-classes.

This hierarchical approach produces a hierarchical set of features or rules, where each internal node of the hierarchy is associated with its corresponding set of features or rules. When classifying a new sample in the test set, the sample is first classified by the feature/rule set associated with the root node. Next, it is classified by the feature/rule set associated with the first-level node whose class was predicted by the feature/rule set at the root (“zero-th”) level, and so on, until the sample reaches a leaf node and is associated to the corresponding leaf-level class. For instance, suppose the sample was assigned to class 1 by the feature/rule set associated with the root node. Next, the sample may be classified by the feature/rule set associated with the class node 1, in order to have its second-level class predicted, and so on, until the sample is assigned to a leaf node class. In this manner, only a portion of a set of classes at a particular level may be used, if desired. This top down technique for classification of the test samples exploits the hierarchical nature of the discovered feature/rule set.

The class hierarchy may be used to select a specific set of positive and negative samples for each run of the technique containing only the samples directly relevant for that particular case. For instance, referring to FIG. 7, building classifier at class node 1, that is a classifier that discriminates among classes 1.1, 1.2, . . . , k1, used only samples belonging to classes 1.1, 1.2, . . . , k1 as training samples. If training a binary classifier at class node 1 for discriminating child-class 1.1 from child-class 1.2, samples of child-class 1.1 may be used as positive examples, and samples of its sibling class(es) 1.2 may be used as negative samples. If training a multi-class classifier at class node 3 for separating class 3.1, 3.2, and 3.3, sample of each child-class 3.1, 3.2, and 3.3 is assigned a unique class label. Therefore, the class hierarchy was used during training to produce compact sets of positive and negative samples associated with the run of the classification technique at each node. Each time the technique was run it was solving a flat classification problem, and it is the many runs of the technique, one run for each internal node of the class hierarchy that produces the hierarchical feature/rule set.

By way of example, the defect classification technique may be applied to liquid crystal displays (LCDs). During the production process of a LCD panel, various types of defects may occur in the LCD panel due to the product processes. Many of the defects may fall into one of four categories, namely, SANSO, UWANO, COAT, and GI. SANSO and UWANO are foreign substances that are deposited onto the LCD panel during the various production stages. SANSO and UWANO both have characteristics of a dark black inner core. The principal difference between the SANSO and UWANO is that the SANSO defect has a pinkish and/or greenish color fringe around the defect border, whereas UWANO does not have such a color fringe around the border. The COAT defect is a bright uniform coat region with a thin dark border and the color of the inner COAT region is similar to the color of the circuit on the LCD panel. The GI defect consists of a colorful rainbow pattern that is typically substantial in size.

Referring to FIG. 8, one class hierarchy is to first divide the four types of defects into “bright defects” 210 and “dark defects” 220 at a first level 200. Then at a second level 230, the “bright defects” 210 are further divided into leaf-class COAT 240 and GI 250, and the “dark defects” 220 are further divided into leaf-class SANSO 260 and UWANO 270. It is noted that the “dark defects” and “bright defects” categories at the first level 200 are “virtual” categories in this example, so each test sample should be only assigned to the leaf node class. However, in other applications the categories at the intermediate levels may be “real” categories, where the samples are permitted to be classified to the intermediate categories.

Referring to FIG. 9, another class hierarchy is to first divide the four types of defects into a leaf-class GI 300 and an intermediate class “non-colorful defects” 310. The GI defects 300 can be regarded as a “colorful defects” category. Then at a second level 320, the “non-colorful defects” 310 are further divided into a leaf class COAT 330 and intermediate class “dark defects” 340. The COAT defects 330 can be regarded as a “bright defects” category. Next, at a third level 350, the “dark defects” 340 are further divided into leaf-classes SANSO 360 and UWANO 370 since both SANSO and UWANO defects are dark defects.

Referring to FIG. 10, a functionality description and a feature set together with a training sample set including positive and negative classes for a class hierarchy suitable for FIG. 8 is illustrated. This illustrates exemplary details some of which may form the basis of the discrimination.

Referring to FIG. 11, a functionality description and a feature set together with a training sample set including positive and negative classes for a class hierarchy suitable for FIG. 9 is illustrated. This illustrates exemplary details some of which may form the basis of the discrimination.

FIG. 12 illustrates an exemplary flow chart for training the classifiers during the training phase for the class hierarchy illustrated in FIG. 8.

FIG. 13 illustrates an exemplary flow chart for training the classifiers during the training phase for the class hierarchy illustrated in FIG. 9.

FIG. 14 illustrates an exemplary flow chart for prediction during the testing phase for the class hierarchy illustrated in FIG. 8.

FIG. 15 illustrates an exemplary flow chart for prediction during the testing phase for the class hierarchy illustrated in FIG. 9.

FIG. 16 illustrates an exemplary defect detection technique for detecting different types of defects, such as for example, defects for liquid crystal panels. The system first receives an input image 400 and a model image 402, and then performs an alignment of the input image to the model image 404. The alignment 404 may be performed by any suitable technique, such as a template matching technique based on gradient feature matching. This matching may consist of a coarse search stage and one or more refinement stages. The coarse search stage may use templates derived from the input image to detect candidate match locations in the model image. The refinement stage(s) perform progressively finer searches for a more precise location of each candidate match. The alignment process then selects the best match from among the candidate matches based upon a match scoring function.

In general, one or more candidate matches may be detected, while typically only one of the candidates is the “correct” match. The challenge is that multiple candidate matches may have quite similar appearance, with the differences between the image areas in the model image corresponding to multiple candidate matches can be small. For example, different parts of the underlying circuit patterns in the model can be quite similar, with only small differences. Hence, these different parts in the image are difficult to discriminate, leaving ambiguity as to which candidate should be selected as the correct match. The alignment 404 may utilize a landmark label image 406, together with the input image 400 and model image 402.

The landmark label image 406 together with the input and model images 400, 402 may be provided to an extraction and modification of a warped model image region process 408. The warped model image region process 408 extracts a region from the model image that corresponds to the input image and warps it into a corresponding relationship for comparison. The warped model image region process 408 provides the input image 400, a warped model image 410, and a warped landmark label image 412. The warped model image 410 is the extraction of that portion of the image of interest. The warped landmark label image 412 is the landmark image map with labels, akin to a segmentation map having “semantic meaning”. The landmark image may identify portions of the landmarks that should have a greater or lesser impact on the alignment. For example, landmark regions of greater importance may be marked relative to landmark regions of lesser importance.

The input image 400, the warped model image 410, and the warped landmark label image 412 may be provided to a defect detection process 414, that identifies the defects 416, such as in the form of a defect mask image. The defect detection includes many challenges one or more may be addressed in a suitable system.

One of the challenges for defect detection that should be addressed is that the input images may have different illumination changes and color patterns compared to the model template image. Input images contain defects may have complicated backgrounds, such as circuit patterns, varying background color, varying levels of blur (focus), and noise. Accordingly, a robust defect detection under such varying imaging conditions is challenging.

Another of the challenges for defect detection that should be addressed is that the input image may include many different types of defects, such as for example, SANSO, UWANO, GI, and COAT. Different classes of defects vary dramatically in their feature representations and therefore it is problematic to utilize a set of generalized features which can handle all types of defects. For example, GI images have a rainbow pattern in color with pink and/or greenish color fringes. For example, COAT images have a similar color as the landmark inside and are not salient compared to SANSO and UWANO defects.

Another of the challenges for defect detection that should be addressed is that often some misalignment between the input image and the model image remains, even after alignment, due to the ambiguity in the landmark structures and image conditions. The alignment stage may identify the correct model image area, however, small differences in the shape and location of the landmark structures in these images will still be present. By way of example, these small differences may lead to false alarms in the detection stage.

In many cases it is desirable to provide a defect detection technique that does not require training. Training based defect detection techniques, such as the classification technique previously described, may be time consuming to implement, and may not be suitable to detect defects with varying characteristics. Moreover, a training based framework often requires a significant amount of training data, and the training process itself tends to be computationally intense.

Referring to FIG. 17, the alignment of the input image 400 to the model image 402 may include a weighted matching technique 450, such that features of discriminative landmarks in the image have a higher contribution in the matching score. The areas in the model image containing discriminative landmarks may be identified in some manner, such as by an operator. This information is assumed to be known a priori and may be stored as a pixel mask in the landmark label image 406, for example, as a one bit plane. The landmark label image 406 and the mask may be prepared a priori. Matching edge pixels in the discriminative areas may be counted with an increased weight, e.g., 4×, 8×, 16×, compared to matching edge pixels in other areas, e.g., 1× (or otherwise relative thereto). The weighted matching technique 450 may be applied in the refinement stages of the alignment process, such that it results in improved locations as well as improved discrimination between candidate match regions.

The weighted matching 450 may be implemented by performing a binary AND operation between a model edge orientation feature image and an input edge orientation feature image, and counting the number of matching pixels. The weighted matching may be implemented by performing the binary AND operation and count operation twice; once with the entire model edge orientation feature image and another time with a masked model edge orientation feature image, where non-discriminative edge features are set to zero.

Another aspect of the alignment process 404, 408 is extending the scoring of the potential candidate matches and ranking those candidates in an order from the greatest likelihood to the least likelihood. For example, a baseline matching score may be computed that is based on the number of edge pixels in the input image and corresponding model image region that have the same local orientation at the same location. The matching scoring function may incorporate a relative penalty for edges that are present in the candidate model image region but not present in the input image.

Such mismatched edge components between the model image and the input image may be isolated by image processing. Subsequently, the number of isolated pixels detected in this manner may be used to penalize the matching score for each candidate. Incorrect candidate matches are likely to be substantially penalized, whereas the correct candidates are not substantially penalized (or penalized by a negligible amount). This image processing may involve applying morphological dilation operators to a binarized input edge image. This binarized input edge image is then negated by a binary NOT operator and matched to a binarized model edge image using a binary AND operator. This process isolates edge pixels that are present in the candidate model image region but not present in the input image or near the input image edge pixels.

Referring to FIG. 18, the alignment technique 404 may estimate the level of blur in the input image using a blur estimation process 460. Images tend to contain varying amount of camera defocus blur primarily due to camera vibration. This defocus blur tends to lead to varying amounts of blur from one image capture to another image capture (i.e., different image captures may have different amounts of blur). This defocus blur often results in the defect detection and/or classification being incorrect, especially when the defocus blur level is sufficiently high.

The blur estimation process 460 may be based upon, an edge pixel selection 461, and estimating the edge width at selected edge points 462. For example, the selection criterion may include selecting edges along horizontal line and vertical line structures of landmarks. For example, the technique may model an edge peak profile as a Gaussian function to estimate the edge width. Based upon the edge width estimation, the local edge width may be computed at each selected edge pixel. The local edge width estimates may be combined into a global blur level estimation 464, e.g., by averaging. The system may decide to skip and/or stop the image processing based upon the global blur level estimation 464.

The warped model image 410 and/or the warped landmark label image 412 may be related based upon geometric relationships between the input image 400 and the matching model image 402 region, such as by translation, rotation, and other parameters, which may be provided to the defect detection 414. The defect detection 414 preferably includes techniques to reduce the effects of illumination and lighting changes in the input image while also enhancing the difference of the potential defect compared to the model image. Referring to FIG. 19, this reduction of illumination/lighting effects while enhancing the difference of the potential defect may be achieved by filling in the dominant color from the landmarks and the background of the input image, respectively, to the warped model image.

The input image 400 may be processed in a suitable manner to identify the dominant background color 500, such as using a three dimensional histogram. The background of the warped model image 410 based upon the warped landmark label image 412 (e.g., may be a binary image identifying the structure of the underlying features) may be replaced with the dominant background color 500 of the input image 400 using a replacement process 510. The landmarks of the warped model image 410 based upon the warped landmark label image 412 (e.g., may be a binary image identifying the structure of the underlying features) may be replaced with a dominant landmark color 505 of the input image 400 using a replacement process 515. The result of the background replacement process 510 and the landmark replacement process 515 is a modified model image 520. In this manner, the colors of the backgrounds and/or landmarks of the input image 400 and the warped model image 410 are similar, so that minor defects in the input image 400 are more readily identifiable. An absolute difference is computed between the input image 400 and the modified model image 520 by a difference process 530. The difference process 530 provides a resulting image 540 that is preferably a direct absolute difference with modified mode image 520. The use of this technique, especially compared to computing the absolute differences between the input image and the warped model image, is (1) a reduction in the effects of differences in the background due to the illumination and lightening changes from the input image; (2) a reduction in bright lines in the difference image that would have otherwise resulted since the model images are imperfectly blended using several sub-images; and (3) a reduction in large differences near landmark features due to imperfect alignment.

Referring to FIG. 20, it is desirable to suppress noise variations in the background portions of the input image and reduce potential misalignment. This noise suppression and reduction of misalignment may be achieved by using thresholds and/or landmark suppression techniques. The resulting image 540, which is a difference based image, may be filtered by a hard threshold 550. The hard threshold 550 may include a fixed binary threshold which reduces small background variations, thus in this manner reduces the small variations of the difference based image. A dilate landmark boundary suppression 560 may dilate the boundary regions of the landmarks in order to reduce misalignment by imposing such dilated boundaries to be zero in the difference image. An adaptive threshold 570 may apply an adaptive threshold based upon a local region of the image, such as an adaptive threshold for each 9×9 pixel block of the image and fitting the pixel intensities in the resulting image (e.g., hard threshold dilated difference map) into a Gaussian distribution. The adaptive threshold 570 tends to reduce slowly varying defects using a local threshold technique. A dilate horizontal, vertical, and/or diagonal corner suppression 580 receives the output of the adaptive threshold 570 and dilates the horizontal, vertical, and/or diagonal corners of the landmark boundaries to reduce the misalignment by imposing such dilated corners to be zero in the difference image. The output of the dilation 580 is provided to a relative threshold 590 that applies a relative threshold, such as, finding the maximum difference in the output of the dilation 580 and threshold the pixels to zero that have a difference less than a percentage of the maximum difference. The relative threshold 590 provides a modified resulting image 595. It is noted that the technique illustrated substantially reduces SANSO and UWANO defects in the input images.

Referring to FIG. 21, the modified resulting image 595 may be processed to detect particular defects, if desired. For example, the modified resulting image 595 may be processed to detect the presence and location of defects related to LCD panels, such as for example, the COAT defect, the SANSO defect, the UWANO defect, and/or the GI defect. A coat detector 600 receives and processes the modified resulting image 595 to identify characteristics representative of a COAT type defect. In the modified resulting image (e.g., a difference based image) a coat type defect is typically indicated by curved boundaries which are connected with a landmark. Accordingly, the coat detector 600 may use a Hough transform to detect straight lines and use an erosion technique to reduce or otherwise remove the detected straight lines. A sanso/uwano detector 610 receives and processes the modified resulting image 595 to identify characteristics representative of the sanso and uwano type defects. The sanso/uwano detector 610 may apply erosion and dilation to the full image, since the defect is not always indicated by curved boundaries which are connected with a landmark. A defect selection 620 may be used to select the better detector 600, 610.

Referring to FIG. 22, the defect selection 620 may be based upon the following criteria. The defect selection 620 may determine if the overlap between the detection of the detectors 600, 610 is greater than a threshold 630. In this manner, the overlap threshold determines if there is a sufficient overlap, which if determined, the defect selection 620 selects the detected region with the larger area 640. Typically this results in the selection of the sanso/uwano type defect from the sanso/uwano detector 610. If there is not sufficient overlap, then the detect selection 620 determines if the aspect ratio (e.g., height to width) of one of the detected blobs is within a certain range 650, such as generally circular. In this manner, the aspect ratio determination determines if the detected blobs are sufficiently circular, which if determined, the aspect selection 650 selects the detected region with the aspect ratio closer to 1 660. Typically, this results in the selection of a blob rather than an elongate line. Typically this results in the selection of the coat type defect from the coat detector 600. If there is not sufficient overlap and the aspect ratios are not within a certain range, then the detected blob with the smaller distance from the center of the blob to the center of the image is selected 670. The selection 670 selects the blob closer to the center of the image since the border region is more likely to be the result of misalignment.

Referring to FIG. 23, the modified resulting image 595 may be processed to detect particular defects, such as for example, the GI defect in a manner separately from the SANSO, UWANO, and COAT defects. The defect detection 414 may select GI image candidates 700. Based upon the selected GI image candidates 700, the defect section 414 may detect color fringes 710. Preferably, the detection of GI defects is based upon a color fringe detector.

Referring to FIG. 24, the selection of GI image candidates 700 is preferably based upon two aspects. The first aspect is the color distribution of the image because GI images usually have long tails of the color distribution compared to other types of defects such as SANSO, UWANO, and COAT. More specifically, in the Lab color space, the maximum value of the “a” component value over all the pixels in the image may be determined and the count of the number of pixels which are smaller than a percentage (e.g., 25%) of the maximum value. If the number of such pixels is larger than zero, or other value, it indicates that the distribution of the “a” color component values has a long tail and it is considered to be a GI image candidate. The second aspect is the variance of the image in the Cb and Cr color space because GI images are usually larger than other types of defects, such as SANSO, UWANO, and COAT. The use of multiple criteria for the selection of GI image candidates enables the system to apply different sets of features and different signal processing techniques for GI images while also limiting the introduction of false alarms for other types of defects.

Referring to FIG. 25, based upon the selection 700 the color fringe detector for GI 710 may be performed. The color fringe detection may include a plurality of features, such as for example five features. The first category of features may be self-contained features that utilize information only from the input image 720. These type of features are selected based upon the color fringe is usually contains certain values in a specific color space (e.g., pinkish and/or greenish color fringes) and often appear in a region having significant color changes. The second category of features may be detected from the modified resulting image 595 (e.g., a difference map) which tend to capture the variation of the input image in certain color spaces 730. These types of features are selected based upon the color fringe usually being significantly different from the dominant color in the background.

Referring also to FIG. 26, the first feature of the first category may be a color fringe detector in the R channel 740. This may be determined as follows. Given the input image in R channel 740, non-uniform quantization is applied 742 first to remove lightening variation in the background. Denote the maximum value in R channel as I_max, the minimum value in R channel as L-min, the pixel value in the ith row and jth column as R(i,j). The non-uniform quantization may be implemented as:

if R(i,j)>0.875*(I_max−I_min) then R(i,j)=0;

if 0.75*I_max−I_min)<R(i,j)<0.875*(I_max−I_min) then R(i,j)=100;

if 0.5*(I_max−I_min)<R(i,j)<0.75*(I_max−I_min) then R(i,j)=50;

if R(i,j)<0.5*(I_max−I_min) then R(i,j)=0.

Then a morphological filtering 743 (e.g., an erosion process and then a dilation process) may be conducted in order to remove noisy artifacts. After the morphological filtering the gradient magnitude 744 may be calculated on the quantized images so as to suppress the uniform background region. The gradient magnitude may be the square root of the sum of the square of the horizontal gradient magnitude and the vertical gradient magnitude where the horizontal gradient magnitude is obtained by convolving the input image by the 3 by 3 filtering mask [−1, −1, −1, 0, 0, 0, 1, 1, 1] and the vertical gradient magnitude may be obtained by convolution with the filtering mask [−1, 0, 1, −1, 0, 1, −1, 0, 1]. Then the process may filter out false positives as a result of geometrical relations of the color fringes and the defects from the modified resulting image 745. The false positive filter may be a distance filter, namely, the color fringe should be sufficiently close to the defect. The false positive filter may be a geometric relation that the defect region should be surrounded by the color fringe. In the luminance space, the system may threshold the pixels which have the luminance smaller than a substantial value (e.g., 230) to be zero 746 to obtain the color fringe detector in R channel 747 since the color fringe usually has a high luminance.

Referring also to FIG. 27, the second feature of the first category may be a color fringe detector in a and b channel 750. This may be determined as follows. Given the input image in the a and b space, apply non-uniform quantization in a and b space, respectively, 752 and take the union of them 754. Denote the maximum value in “a” channel as a_max, maximum value in “b” channel as b_max, the pixel value in the ith row and jth column as a(i,j) for channel “a”, the pixel value in the ith row and jth column as b(i,j) for channel “b”.

if a(i,j)>0.75*a_max then a(i,j)=0;

if 0.25*a_max<a(i,j)<0.75*a_max then a(i,j)=100;

if a(i,j)<0.25*b_max then a(i,j)=0;

if b(i,j)>0.75*b_max then b(i,j)=0;

if 0.25*b_max<b(i,j)<0.75*b_max then b(i,j)=100;

if b(i,j)<0.25*b_max then b(i,j)=0.

Then the color fringe detector may threshold the results by rejecting the non-zero pixels which are sufficient far away from the defect in the modified resulting image to obtain the color fringe in the Lab space 756.

Referring also to FIG. 28, the first feature of the second category may be a Lab difference 760 with modified resulting images in a and b spaces 762. This may be determined in a manner similar to the manner in which the resulting image 540 is determined, as applied to the a and b color space. In general, the absolute direct difference 766 between the input image 764 and the modified resulting image 762 by filling the dominant color in the a and b spaces, respectively. Then the system may apply a relative threshold 767 multiplied by the maximum value in the a and b spaces, respectively. Subsequently, morphological filtering and erosion 768 may be employed to the thresholded feature map. Finally, the feature map in the a and b spaces may be combined 769.

Referring also to FIG. 29, the second feature of the second category may be Cb and Cr differences 770 with the modified resulting images in Cb and Cr spaces 772. This may be determined in a manner similar to the manner in which the resulting image 540 is determined, as applied to the Cr and Cb color space. In general, the absolute direct difference 775 between the input image 774 and the modified resulting image 772 by filling the dominant color in the a and b spaces, respectively. Then the system may apply a relative threshold 776 multiplied by the maximum value in the Cb and Cr spaces, respectively. Subsequently, an AND operation 777 may use the thresholded feature map with the background labels to suppress the landmarks. Finally, the feature map in the Cb and Cr spaces may be combined 778.

Referring also to FIG. 30, the third features of the second category may be brightness difference 780. This may be determined as follows. In general, the absolute direct difference 786 between the input image 784 and the modified resulting image 782 in the brightness space computed as the average of the sum of RGB space. Then the system may apply a relative threshold 787 multiplied by the maximum value in the brightness space. Subsequently, an AND operation with the background labels may be used to suppress the landmark 788.

The color fringe detector for GI images 710 may be any suitable function, such as an OR operation of any of the features.

The shapes of the COAT, SANSO, and/or UWANO defect images may be refined 621 (see FIG. 21). For example, adaptive bounding boxes may be used to detect SANSO color fringes within the bounding boxes, which is useful to discriminate between SANSO and UWANO. Also, the SANSO defect may be dilated as an adaptive bounding box, and then compute thresholded Cr difference map within the adaptive bounding box using an AND operation. For example, a Cr difference may be used to refine the COAT defect shape, where the Cr difference feature is selectively applied to images whose Cr difference is salient. This may be performed by computing the variance of the horizontal and vertical coordinates of the non-zero pixels in the Cr difference feature map. If the variance is smaller than a threshold, it implies that the feature is salient and the corresponding feature map should be incorporated into the detection. Subsequently, the system may reject the blogs in this feature map which are far away from a certain threshold compared to the original defect from the direct difference map.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for image processing comprising:
(a) learning a model hierarchical classification structure of a plurality of different objects, wherein said hierarchical classification structure includes one multi-class classifier or multiple binary classifiers in the first layer for categorizing a plurality of first layer classes each of which is characterizing one of said plurality of different objects, and one multi-class classifier or multiple binary classifiers in the second layer for categorizing a plurality of second layer classes wherein each of said second layer of classes further characterizes one of plurality of first layer classes;
(b) receiving an input image;
(c) categorizing said input image using a statistical model using said first layer classifier(s) of the model hierarchical classification structure for said first layer of said plurality of first layer classes;
(d) further categorizing said input image using a statistical model using said second layer classifier(s) of the model hierarchical classification structure for said second layer of said plurality of second layer classes, where said categorizing of step (c) among said first layer of said plurality of first layer classes is independent of the classification decision of said categorizing of step(d) among said second layer of said plurality of second layer classes.

2. The method of claim 1 further categorizing said input image using a statistical model using said model hierarchical classification structure for at least one additional layer of classes.

3. The method of claim 1 wherein said categorizing of said input image using said statistical model using said model hierarchical classification structure for said second layer of said plurality of second layer classes includes at least one of (1) only those said plurality of second layer classes that further categorize one or more of said first plurality of classes selected as a result of step(c) and (2) is dependent of the classification decision of said categorizing among said first layer of said plurality of first layer classes,

4. The method of claim 1 wherein said model hierarchical classification structure is generated in a top-down fashion by either training a single multi-class classifier for each internal class node at each layer, or training multiple binary classifiers for each internal class node at each layer.

5. The method of claim 1 wherein said classification model of said each internal classifier of said hierarchical classification structure includes at least one of a SVM, a Random Trees, a Neural Network, a Decision Trees and a Bayesian Classifier.

6. The method of claim 1 wherein said model hierarchical classification structure wherein each internal classifier associated with each internal class node includes a rule set and a feature set for discriminating the objects of one child-class of said internal class node from the objects of the other child-class of said internal class node.

7. The method of claim 6 wherein the set of features used at said each internal node of said model hierarchical classification structure may be automatically discovered by at least one of (1) a feature selection technique (e.g., using mutual information between a feature F and a category C), or and (2) defined by an operator where the operator selects discriminating features for differentiating the sub-classes.

8. A method for image processing comprising:
(a) providing a model image;
(b) providing a landmark image defining relevant structures within said model image;
(b) receiving an input image;
(c) aligning said input image with said model image based at least in part upon said landmark image;
(d) wherein features of said input image corresponding to greater discriminative landmarks of said landmark image have a higher contribution to said alignment than less discriminate landmarks of said landmark image.

9. The method of claim 8 wherein said aligning includes a matching score of a plurality of candidates.

10. The method of claim 9 wherein said discriminative landmarks selects among a plurality of said candidates.

11. A method for image processing comprising:
(a) providing a model image;
(b) receiving an input image;
(c) aligning said input image with said model image based at least upon edges of said input image and edges of said model image;
(d) scoring said aligning based upon a different contribution for said edges of said input image that match with said edges of said model image and a contribution for edges of said model image that are not matched with said input image.

12. The method of claim 11 wherein said scoring for one of said contributions is a negative score.

13. The method of claim 12 wherein said scoring for one of said contributions is a positive score.

14. A method for image processing comprising:
(a) providing a model image;
(b) receiving an input image;
(c) estimating a blur of said input image;
(d) aligning said input image with said model image if said estimated blur is less than a threshold value.

15. The method of claim 14 wherein said blur is estimated based upon edge width.

16. The method of claim 15 wherein said edge width is based upon edges of landmark structures in said input image.

17. A method for image processing comprising:
(a) providing a model image;
(b) providing a landmark image defining relevant structures within said model image;
(c) receiving an input image;
(d) modifying said model image by replacing a background region of said model image, as defined by said landmark image, with a dominant background color of said input image;
(e) modifying said model image by replacing a landmark region of said model image, as defined by said landmark image, with a dominant landmark color of said input image;
(f) detecting defects within said input image by comparing said input image with said modified model image.

18. The method of claim 17 wherein said detecting defects is based upon a difference between said input image and said modified model image.

19. A method for image processing comprising:
(a) providing a model image;
(b) providing a landmark image defining relevant structures within said model image;
(c) receiving an input image;
(d) detecting defects within said input image by comparing said input image with said modified model image based upon a dilation of landmarks defined by said landmark image.

20. The method of claim 19 wherein said comparing is further based upon attenuating small variations.

21. The method of claim 20 wherein said comparing is further based upon applying an adaptive threshold.

22. The method of claim 21 wherein said comparing is further based upon applying a relative threshold.

23. The method of claim 19 wherein said dilation of landmarks defined by said landmark image includes (1) dilation of landmark straight boundaries, and (2) dilation of corners of said landmark boundaries.

24. A method for image processing comprising:
(a) providing a model image;
(b) receiving an input image;
(c) determining a difference image between said model image and said input image;
(d) identifying defects in said difference image based upon using a plurality of detectors, each of said plurality of detectors being different from one another, one of said plurality of detectors identifying curved boundaries connected with a landmark boundary of a landmark image, and another of said plurality of detectors identifying straight lines a landmark boundary of said landmark image.

25. The method of claim 24 wherein a first of said detectors is a COAT detector, a second of said detectors is a SANSO detector.

26. The method of claim 24 wherein one of said identified defects is selected based upon overlapping.

27. A method for image processing comprising:
(a) providing a model image;
(b) receiving an input image;
(c) determining a difference image between said model image and said input image;
(d) identifying first defects in said difference image;
(e) identify second defects in said input image based upon a color distribution of said input image;
(f) selecting one of said first defects and said second defects.

28. The method of claim 27 wherein said second defects are GI defects.

29. The method of claim 27 wherein said first defects are at least one of SANSO, UWANO, and COAT.

30. A method for image processing comprising:
(a) providing a model image;
(b) receiving an input image;
(c) identifying defects in said input image based upon color fringes in said input image and based upon color fringes in a difference image between said model image and said input image.

31. The method of claim 30 wherein said identifying defects is GI defects.
